(19) United States
(12) Patent Application Publication
(10) Pub. No.: US 2008/0231028 A1
(43) Pub. Date: Sep. 25, 2008

(54) Safety Device for Protecting Occupants of a Motor Vehicle in a Rollover Event

(75) Inventors: Hermann Brandsch, Stuttgart (DE); Stephan Wetzel, Weissach (DE); Martin Kane, Oberriexingen (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 12/053,696

(22) Filed: Mar. 24, 2008

(30) Foreign Application Priority Data
Mar. 23, 2007 (DE) 10 2007 014 125.6

(51) Int. Cl. B60R 21/02

(52) U.S. Cl. 280/753

(57) ABSTRACT

In the case of a safety device for protecting occupants of a motor vehicle in the event of a rolling over of the vehicle, the motor vehicle passenger compartment has doors with side windows manufactured from glass in the region of the side walls. To reliably avoid occupants who are not wearing seat belts being flung out of the passenger compartment through the side windows, it is provided that the side windows are produced from a special laminated glass, for example with high-strength ionoplast interlayers, and that, in the event of a rolling over of the vehicle, the side windows are additionally assigned side impact protection devices integrated in the doors and/or seats.

### CROSS-REFERENCE TO RELATED APPLICATION

This application claims the priority, under 35 U.S.C. § 119, of German application DE 10 2007 014 125.6, filed Mar. 23, 2007; the prior application is herewith incorporated by reference in its entirety.

### BACKGROUND OF THE INVENTION

### Field of the Invention

The invention relates to a safety device for protecting occupants of a motor vehicle in the event of a rollover of the vehicle. The motor vehicle passenger cell has doors with side windows manufactured from glass in the region of the side walls.

In many countries, there is mandatory seat belt usage for the occupants of a motor vehicle, and therefore the occupants who are buckled up by a seat belt system remain protected on their seats within the passenger cell in the event of a rolling over of the vehicle. However, in some regions, for example in a number of US states, there is no mandatory seat belt usage for the occupants of a motor vehicle.

It is possible, under very unfavorable circumstances, that, for motor vehicle occupants who are not wearing seat belts, the side windows, which are generally manufactured from toughened safety glass, burst apart in the event of a rollover of the vehicle and that the occupants who are not wearing seat belts are flung out of the passenger compartment through the side-window openings, which are now completely exposed, and, in the process, suffer severe injuries.

### BRIEF SUMMARY OF THE INVENTION

It is accordingly an object of the invention to provide a rollover protection device, which overcomes the above-mentioned disadvantages of the heretofore-known devices and methods of this general type and which provides for specific precautions in a motor vehicle such that occupants who are not wearing seat belts reliably avoid being flung out of the passenger compartment of the motor vehicle through the side window in the case of an accident.

With the foregoing and other objects in view there is provided, in accordance with the invention, a safety device for protecting occupants of a vehicle in the event of a rollover of the vehicle, the vehicle having a passenger compartment bounded by a door having a side window opening formed therein. The safety device comprises the following:

a side window pane disposed in the side window opening of the door, the side window pane being formed of a special laminated glass with a high-strength plastic interlayer; and

side impact protection devices integrated in the door and/or a passenger seat and disposed to be effective at the side window opening in the event of a rollover of the vehicle.

In accordance with an added feature of the invention, the high-strength plastic interlayer is produced from an ionoplast or from a polyethylene (PE) ionomer.

The advantages primarily obtained by the invention include the fact that the occupants reliably avoid being flung out of the passenger compartment in particular by the side windows of the vehicle being formed from a special laminated glass, for example with high-strength ionoplast interlayers. The side windows which are formed in such a manner are substantially more stable and have a significantly greater impact toughness than laminated windows with conventional PVB interlayers, and therefore the side windows do not become unstable in the event of a rolling over of the vehicle but rather remain stable even after being subjected to a load.

The protective effect for motor vehicle occupants who are not wearing seat belts is additionally increased in that, in the event of a rolling over of the vehicle, each side window is assigned a side impact protection device which is integrated in the doors and/or seats and protects the head region and the thorax region of the occupants.

Therefore, in accordance with a concomitant feature of the invention, the side impact protection device includes a head airbag disposed at a ledge of the door and disposed for upward deployment by a first inflating device, and a thorax airbag disposed for lateral deployment out of the seat by a second inflating device.

Other features which are considered as characteristic for the invention are set forth in the appended claims.

Although the invention is illustrated and described herein as embodied in safety device for protecting occupants of a motor vehicle in the event of a rollover of the vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a partial cross section through a motor vehicle body with the safety device according to the invention;

FIG. 2 is a side view thereof in the direction of arrow A of FIG. 1; and

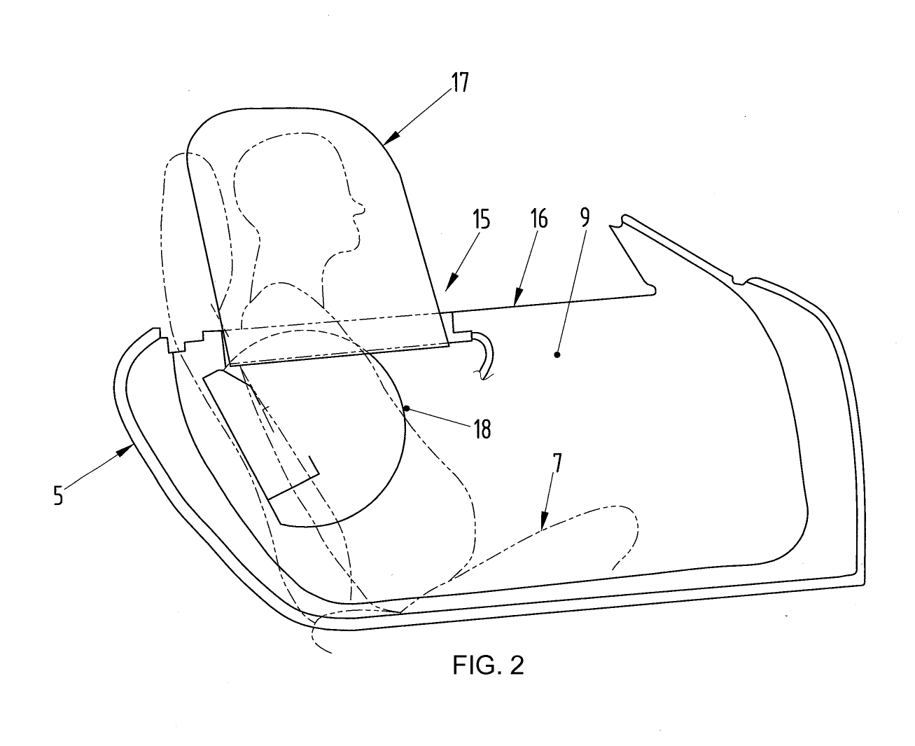

FIG. 3 is a section taken along the line III-III of FIG. 1 through the side window in a larger illustration and rotated through 90°.

### DETAILED DESCRIPTION OF THE INVENTION

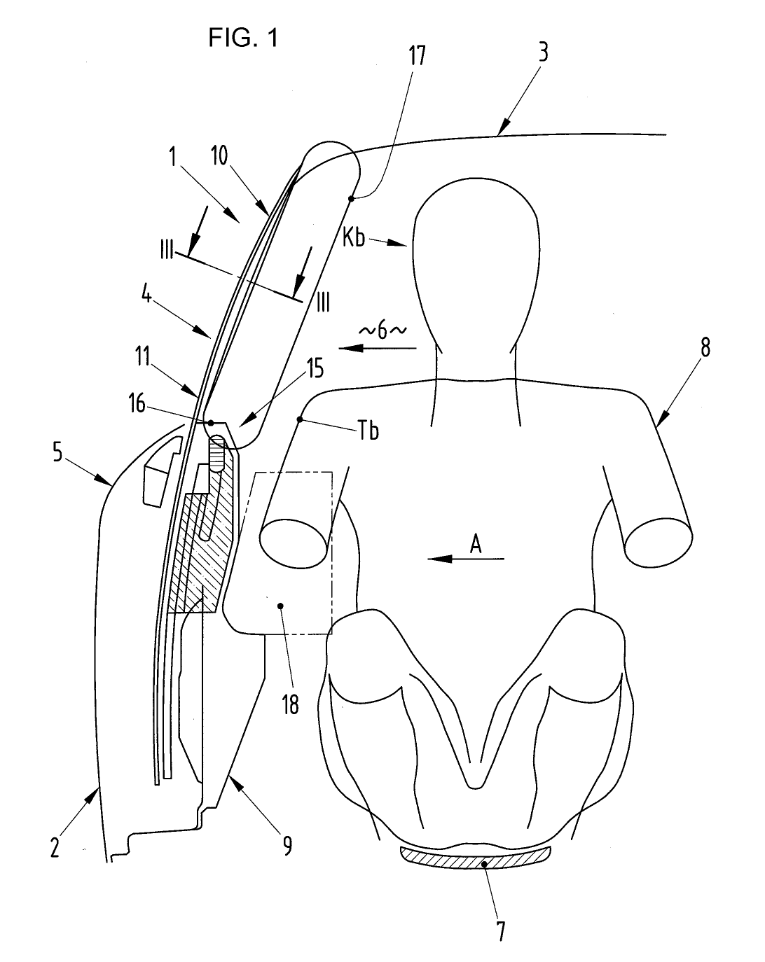

Referring now to the figures of the drawing in detail and first, particularly, to FIG. 1 thereof, a motor vehicle 1 comprises a chassis or body 2 with a roof 3 and a side wall 4 in which a door 5 is inserted.

The door 5 delimits a passenger compartment 6 for at least one occupant 8 sitting on a seat 7. The door 5 has a door body 9 and a side window 10 mounted in the door body so that it can be lowered. In order to protect the occupants who are not wearing seat belts in the event of a rollover of the vehicle, in particular in the event of a rolling over of the vehicle in the transverse direction of the vehicle, a safety device 11 is provided.

The safety device 11 is formed, firstly, by the side windows 10 being formed from a special laminated glass, with a high-strength plastic interlayer 12, for example an ionoplast. In comparison to conventional PVB interlayers (polyvinyl butyral), a high-strength ionoplast intermediate layer 12 is substantially tougher and stiffer, and therefore the side windows 10 do not become unstable in the event of a rolling over the vehicle, but rather remain largely stable.

This ensures that occupants 8 who are not wearing seat belts cannot be flung out of the passenger compartment 6 through the bodywork openings of the side windows 10 in the doors when the side windows 10 are closed.

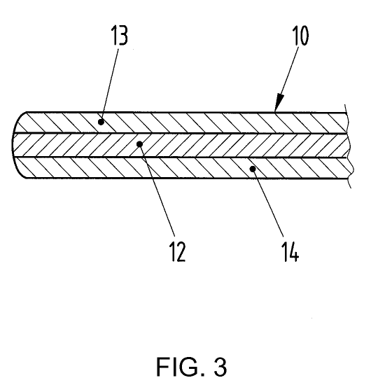

The basic construction of the side windows 10 is illustrated in more detail in FIG. 3. Each side window 10 comprises at least two outer glass panes 13, 14 which are connected by a high-strength, adhesive interlayer, for example a high-strength ionoplast interlayer 12. For example, the product SentryGlas® Plus from DuPont constitutes a laminated glass pane of this type. Of course, instead of the ionoplast interlayer 12, use may also be made of other interlayers with similar material properties.

The safety device 11 is formed, secondly, by a side impact protection device 15 assigned to the side windows 10, the side impact protection device being integrated in the doors and/or seats. The side impact protection device 15 serves in particular to protect the thorax region Tb and the head region Kb of the occupant 8 and acts as a passive safety system, which is known in motor vehicle manufacturing under the term airbag, in which a pyrotechnic propellant is ignited in the event of a collision of the vehicle. As a result, a protective bag is inflated within fractions of a second.

In the exemplary embodiment, the side impact protection device 15 comprises a head airbag 17 which is arranged in the region of the ledge 16 of the side wall 4 or of the door 5, can be deployed upward and has a first inflating device, and a thorax airbag 18 which can be deployed laterally out of the seat 7 and has a second inflating device. Such a side impact protection device can be found, for example, in the commonly assigned German published patent application DE 102 57 248 A1 (cf. U.S. Pat. No. 7,207,596 B2).

1. A safety device for protecting occupants of a vehicle in the event of a rollover of the vehicle, the vehicle having a passenger compartment bounded by a door having a side window opening formed therein, the safety device comprising:
a side window pane disposed in the side window opening of the door, the side window pane being formed of a special laminated glass with a high-strength plastic interlayer; and
side impact protection devices integrated in at least one of the door and a passenger seat and disposed to be effective at the side window opening in the event of a rollover of the vehicle.

2. The safety device according to claim 1, wherein said high-strength plastic interlayer is produced from an ionoplast.

3. The safety device according to claim 1, wherein said high-strength plastic interlayer is produced from a polyethylene ionomer.

4. The safety device according to claim 1, wherein said side impact protection device includes a head airbag disposed at a ledge of the door and mounted for upward deployment by a first inflating device, and a thorax airbag disposed for lateral deployment out of the seat by a second inflating device.
